(19) United States
(12) Patent Application Publication
(10) Pub. No.: US 2021/0129083 A1
(43) Pub. Date: May 6, 2021

(54) FILTRATION APPARATUS

(71) Applicant: SUMITOMO ELECTRIC INDUSTRIES, LTD., Osaka-shi, Osaka (JP)

(72) Inventors: Hiroko MIKI, Sennan-gun, Osaka (JP); Keiichi IKEDA, Sennan-gun, Osaka (JP); Toru MORITA, Sennan-gun, Osaka (JP)

(73) Assignee: SUMITOMO ELECTRIC INDUSTRIES, LTD., Osaka-shi, Osaka (JP)

(21) Appl. No.: 16/476,665

(22) PCT Filed: Jan. 13, 2017
(86) PCT No.: PCT/JP2017/001127

§ 371 Date: Jul. 9, 2019

(51) Int. Cl. B01D 63/04; B01D 65/02

(52) U.S. Cl. CPC B01D 63/04; B01D 65/02; B01D 2321/185; B01D 2319/04; B01D 2315/06

(57) ABSTRACT

An object of the present invention is to provide a filtration apparatus capable of achieving space-saving of the entire apparatus. A filtration apparatus according to the present invention includes a plurality of filtration modules that each include a plurality of hollow fiber membranes that are arranged adjacent to each other so as to extend in an up-down direction, a washing module configured to supply air bubbles from below the plurality of filtration modules, and a frame that supports the plurality of filtration modules. The washing module includes a plurality of aeration tubes each having a plurality of aeration holes. At least a portion of the frame is a hollow tube through which a gas is supplied to the plurality of aeration tubes.

### TECHNICAL FIELD

The present invention relates to a filtration apparatus.

### BACKGROUND ART

Typically, a filtration apparatus that includes a plurality of filtration modules including a plurality of hollow fiber membranes bundled together is used as a solid liquid separation treatment apparatus for waste water treatment and the like. The filtration apparatus is used by being immersed in a liquid to be treated and prevents, by using surfaces of the hollow fiber membranes, impurities that are contained in the liquid to be treated and that have a certain particle diameter or more from penetrating therethrough, thereby performing filtration treatment.

The more the filtration apparatus is used, the more the impurities adhere to the surfaces of the hollow fiber membranes, which degrades treatment capacity. Thus, the filtration apparatus includes a washing module for supplying air bubbles from below the plurality of filtration modules. The filtration apparatus is capable of removing impurities adhering to the surfaces of the plurality of hollow fiber membranes by causing the air bubbles to scour the surfaces of the plurality of hollow fiber membranes to cause the hollow fiber membranes to swing.

Regarding such a filtration apparatus, there is proposed a filtration apparatus that includes a plurality of filtration modules supported by a frame (refer to International Publication No. 2016-152336).

### CITATION LIST

### Patent Literature

PTL 1: International Publication No. 2016-152336

### SUMMARY OF INVENTION

A filtration apparatus according to an aspect of the present invention includes a plurality of filtration modules that each include a plurality of hollow fiber membranes that are arranged adjacent to each other so as to extend in an up-down direction, a washing module configured to supply air bubbles from below the plurality of filtration modules, and a frame that supports the plurality of filtration modules. The washing module includes a plurality of aeration tubes each having a plurality of aeration holes. At least a portion of the frame is a hollow tube through which a gas is supplied to the plurality of aeration tubes.

### BRIEF DESCRIPTION OF DRAWINGS

FIG. 1 is a schematic perspective view of a filtration apparatus according to an embodiment of the present invention.

FIG. 2 is a schematic back view of the filtration apparatus in FIG. 1.

FIG. 3 is a schematic perspective view of a filtration module of the filtration apparatus in FIG. 1.

FIG. 4 is a schematic partial enlarged perspective view of a connection structure of a hollow tube and a gas-introducing tube of the filtration apparatus in FIG. 1.

FIG. 5 is a schematic perspective view of a frame and a washing module of the filtration apparatus in FIG. 1.

FIG. 6 is a schematic perspective view of an existing filtration unit.

FIG. 7 is a schematic perspective view of an existing filtration unit according to a form that differs from that of the filtration unit in FIG. 6.

### DESCRIPTION OF EMBODIMENT

### [Problem to be Solved by Present Invention]

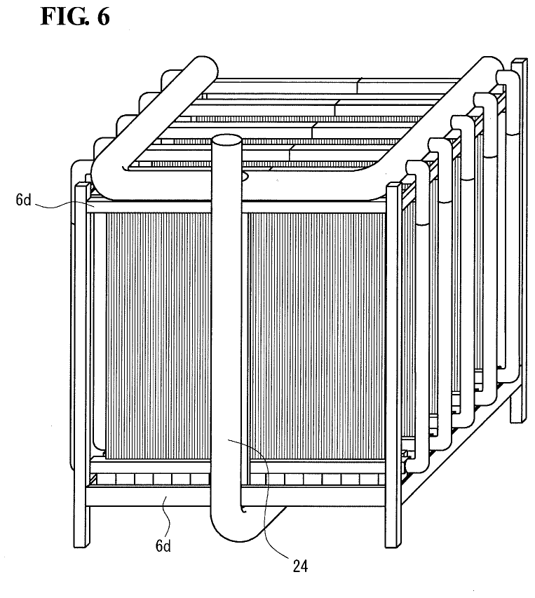

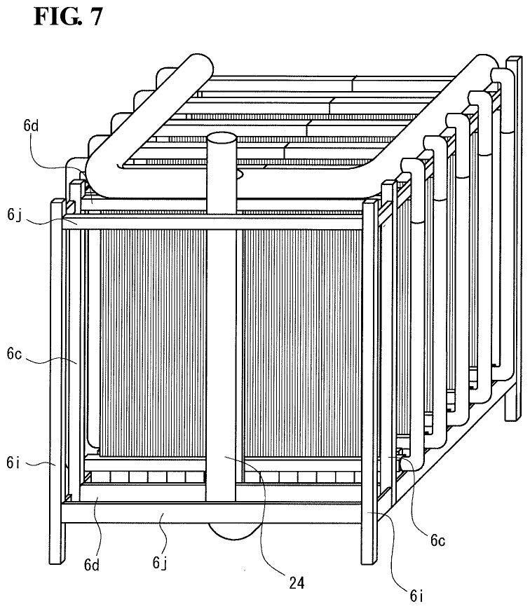

The filtration unit described in the aforementioned publication includes a pair of front vertical frames and a pair of rear vertical frames, the vertical frames forming four corners of a support structure of the plurality of filtration modules in plan view. The plurality of filtration modules are disposed inside a region surrounded by these vertical frames. The filtration unit includes a pair of front horizontal frames, a pair of rear horizontal frames, a pair of right horizontal frames, and a pair of left horizontal frames, the horizontal frames being suspended between upper portions and between lower portions of these vertical frames. The filtration unit includes, as a washing module, a plurality of aeration tubes that are disposed below the plurality of filtration modules, and a supply pipe through which a gas is supplied to the plurality of aeration tubes. As illustrated in FIG. 6, the filtration unit includes a supply pipe 24 disposed outside a pair of rear horizontal frames 6d. It is considered to provide such a filtration unit, as illustrated in FIG. 7, with a pair of outer vertical frames 6i that are disposed at the rear of a pair of rear vertical frames 6c, and a pair of outer horizontal frames 6j that are disposed at the rear of a pair of rear horizontal frames 6d. The filtration unit in FIG. 7 protects the supply pipe 24 from outside with the pair of outer vertical frames 6i and the pair of outer horizontal frames 6j.

The filtration unit uses the frames to support the plurality of filtration modules, which enables these filtration modules to be disposed in a relatively dense manner. However, in the filtration unit, the pair of the front vertical frames and the pair of the rear vertical frames, the pairs forming the four corners of the support structure of the plurality of filtration modules, are disposed close to the plurality of filtration modules so as to surround the plurality of filtration modules in plan view. Therefore, it is difficult to dispose the supply pipe inside the area surrounded by these vertical frames. Thus, in the filtration unit, the supply pipe is disposed outside the region surrounded by the pair of the front vertical frames and the pair of the rear vertical frames, as described above, and the supply pipe hinders space-saving of the entire apparatus.

The present invention was developed on the basis of such a circumstance, and an object of the present invention is to provide a filtration apparatus capable of achieving space-saving of the entire apparatus.

### [Advantageous Effects of Invention]

The filtration apparatus according to the present invention is capable of achieving space-saving of the entire apparatus. In addition, the filtration apparatus according to the present invention is capable of reducing the number of components and achieving weight saving of the entire apparatus.

### DESCRIPTION OF EMBODIMENT OF PRESENT INVENTION

First, an embodiment of the present invention will be listed and described.

A filtration apparatus according to an embodiment of the present invention includes a plurality of filtration modules that each include a plurality of hollow fiber membranes that are arranged adjacent to each other so as to extend in an up-down direction, a washing module configured to supply air bubbles from below the plurality of filtration modules, and a frame that supports the plurality of filtration modules. The washing module includes a plurality of aeration tubes each having a plurality of aeration holes. At least a portion of the frame is a hollow tube through which a gas is supplied to the plurality of aeration tubes.

Due to at least a portion of the frame that supports the plurality of filtration modules being the hollow tube through which a gas is supplied to the plurality of aeration tubes, the filtration apparatus does not require a gas supply pipe for supplying a gas to the plurality of aeration tubes to be provided separately from the frame. The filtration apparatus is thus capable of preventing a size increase of the apparatus due to the gas supply pipe. Accordingly, the filtration apparatus is capable of achieving space-saving of the entire apparatus. In addition, due to the gas supply pipe not being required to be provided separately from the frame, the filtration apparatus is capable of reducing the number of components and achieving weight saving of the entire apparatus.

Preferably, the hollow tube is disposed so as to extend in the up-down direction. The hollow tube that is thus disposed so as to extend in the up-down direction makes it easy to increase the strength of the frame while supplying a gas to the plurality of aeration tubes through the hollow tube.

Preferably, the washing module includes a gas-introducing tube in communication with the plurality of aeration tubes, and the hollow tube is in communication with the gas-introducing tube. The washing module that thus includes the gas-introducing tube in communication with the plurality of aeration tubes and the hollow tube that is thus in communication with the gas-introducing tube make it possible to supply a gas to the plurality of aeration tubes through the single hollow tube. Consequently, it is possible to simplify the apparatus, which enables space-saving of the entire apparatus to be achieved easily. Moreover, this configuration makes it easy to promote a reduction in the number of components and weight saving of the entire apparatus.

Preferably, the frame includes the hollow tube as a single hollow tube, and the hollow tube is in communication with one end portion of the gas-introducing tube. The frame that thus includes the hollow tube as a single hollow tube and the hollow tube that is thus in communication with the one end portion of the gas-introducing tube make it easy to uniformly supply air bubbles from the plurality of aeration holes of the plurality of aeration tubes, through the gas-introducing tube, to the plurality of hollow fiber membranes. Consequently, it is possible to improve washing efficiency of the washing module while achieving space-saving of the entire apparatus.

Preferably, the frame includes four vertical frame members that are disposed at four corners of a support structure in plan view, four upper horizontal frame members that are suspended between upper end portions of the vertical frame members adjacent to each other, and four lower horizontal frame members that are suspended between lower end portions of the vertical frame members adjacent to each other, and the hollow tube is connected, between a pair of the vertical frame members adjacent to each other, to the upper horizontal frame members and the lower horizontal frame members. The hollow tube that is thus connected, between the pair of the vertical frame members adjacent to each other, to the upper horizontal frame members and the lower horizontal frame members makes it possible to reinforce the support structure of the plurality of filtration modules by the hollow tube. Moreover, this configuration shortens a gas flow path, which makes it possible to promote simplification of the apparatus and efficiency improvement in washing.

Note that, in the present invention, “up” denotes ‘up’ in a use state (state of being immersed in a liquid to be treated) of the filtration apparatus of the present invention, and “down” denotes opposite.

### DETAILS OF EMBODIMENT OF PRESENT INVENTION

Hereinafter, a filtration unit according to an embodiment of the present invention will be described with reference to the drawings.

### [Filtration Apparatus]

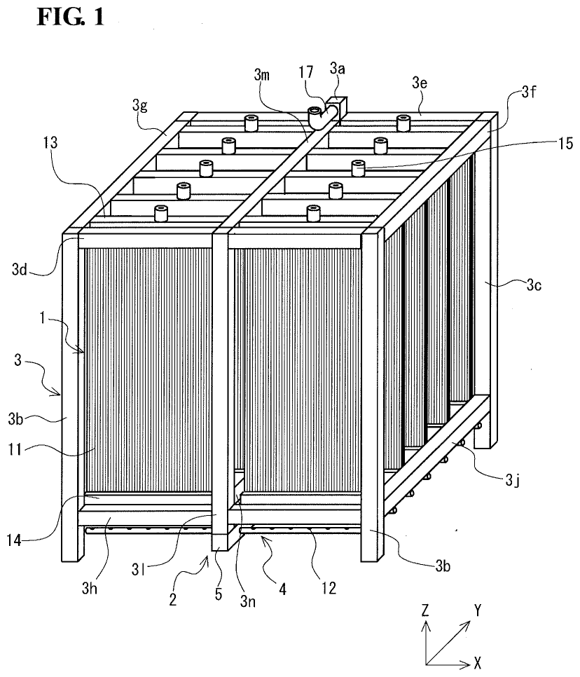

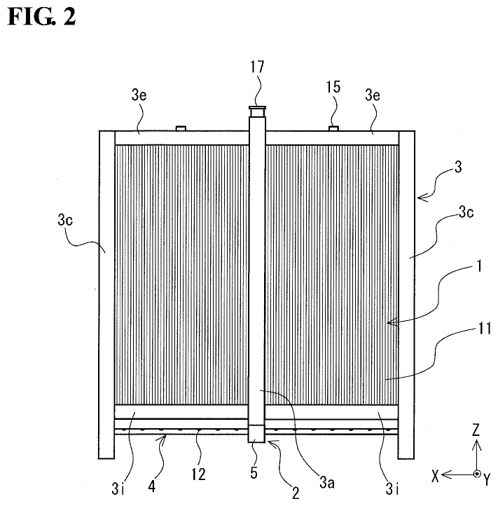

The filtration apparatus in FIG. 1 and FIG. 2 includes a plurality of filtration modules 1 that each include a plurality of hollow fiber membranes 11 that are arranged adjacent to each other so as to extend in the up-down direction, a washing module 2 configured to supply air bubbles from below the plurality of filtration modules 1, and a frame 3 that supports the plurality of filtration modules 1. The washing module 2 includes a plurality of aeration tubes 4 each having a plurality of aeration holes 12, and a gas-introducing tube 5 that is in communication with the plurality of aeration tubes 4. In the filtration apparatus, the frame 3 includes one frame that is a hollow tube 3a through which a gas is supplied to the plurality of aeration tubes 4. In other words, an internal space of the hollow tube 3a is formed as a guiding passage through which a gas is supplied to the plurality of aeration tubes 4. The filtration apparatus is used by being immersed in a liquid to be treated. The filtration apparatus is an external pressure-type or immersion-type filtration apparatus that prevents impurities that are contained in a liquid to be treated and that have a certain particle diameter or more from penetrating through the hollow fiber membranes 11, thereby performing filtration treatment. Note that ‘external pressure-type’ is a method in which the outer surface side of the hollow fiber membranes is subjected to a high pressure so that a liquid to be treated is caused to permeate to the inner surface side of the hollow fiber membranes. In addition, ‘immersion-type’ is a method in which the inner surface side of the hollow fiber membranes is subjected to a negative pressure so that a liquid to be treated is caused to permeate to the inner surface side. The ‘immersion-type’ is also known as ‘suction-type’.

Due to the frame 3 that supports the plurality of filtration modules 1 including the one frame that is the hollow tube 3a through which a gas is supplied to the plurality of aeration tubes 4, the filtration apparatus does not require a gas supply pipe for supplying a gas to the plurality of aeration tubes 4 to be provided separately from the frame 3. The filtration apparatus is thus capable of preventing a size increase of the apparatus due to the gas supply pipe. Accordingly, the filtration apparatus is capable of achieving space-saving of the entire apparatus. In addition, due to the gas supply pipe not being required to be provided separately from the frame 3, the filtration apparatus is capable of reducing the number of components and achieving weight saving of the entire apparatus.

### <Filtration Module>

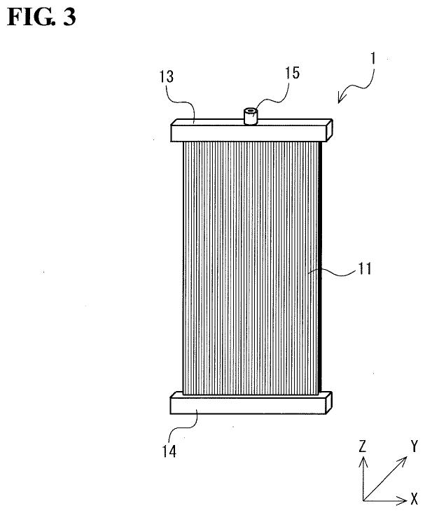

As illustrated in FIG. 3, the filtration modules 1 each include the plurality of hollow fiber membranes 11 that are arranged adjacent each other so as to extend in the up-down direction, an upper holding member 13 that fixes upper ends of the plurality of hollow fiber membranes 11, and a lower holding member 14 that fixes lower ends of the plurality of hollow fiber membranes 11. The upper holding member 13 and the lower holding member 14 each have a bar shape. The plurality of hollow fiber membranes 11 are connected to a substantially entire surface of each of a lower surface of the upper holding member 13 and an upper surface of the lower holding member 14. With such a configuration, each of the filtration modules 1 has a substantially rectangular parallelepiped shape whose thickness (length in the horizontal direction perpendicular to a center axis direction of the upper holding member 13 and the lower holding member 14) is smaller than the width (length in the center axis direction of the upper holding member 13 and the lower holding member 14) thereof. The upper holding member 13 includes a filtered-water passage that is in communication with internal spaces of the plurality of hollow fiber membranes 11 and through which a filtered water obtained through filtration by the plurality of hollow fiber membranes 11 is collected, and a drainage nozzle 15 through which the filtered water is drained from the filtered-water passage to the outside. The drainage nozzle 15 is connected to a drainage mechanism (not illustrated) configured to drain the filtered water obtained through filtration by the filtration modules 1. Note that, in the following description, the up-down direction in FIG. 1 is referred to as a Z direction, the center axis direction of the upper holding member 13 and the lower holding member 14 is referred to as an X direction, and the direction perpendicular to the X direction in the horizontal direction is referred to as a Y direction.

The plurality of filtration modules 1 are disposed in two rows. The plurality of filtration modules 1 are disposed parallel to each other with an equal interval therebetween in each row. Specifically, the plurality of filtration modules 1 are disposed in two rows in the X direction such that respective edges in the width direction are adjacent to each other and disposed with an equal interval therebetween so as to face each other in the thickness direction in each row.

The hollow fiber membranes 11 are tubular porous membranes that allow water to permeate therethrough and that inhibit permeation of impurities that are contained in a liquid to be treated and that have a certain particle diameter or more. The hollow fiber membranes 11 contain, for example, a thermoplastic resin as a main component. Note that “main component” denotes the most contained component, for example, a component contained at 50 mass % or more.

### <Washing Module>

As described above, the washing module 2 includes the plurality of aeration tubes 4 and the gas-introducing tube 5 in communication with the plurality of aeration tubes 4.

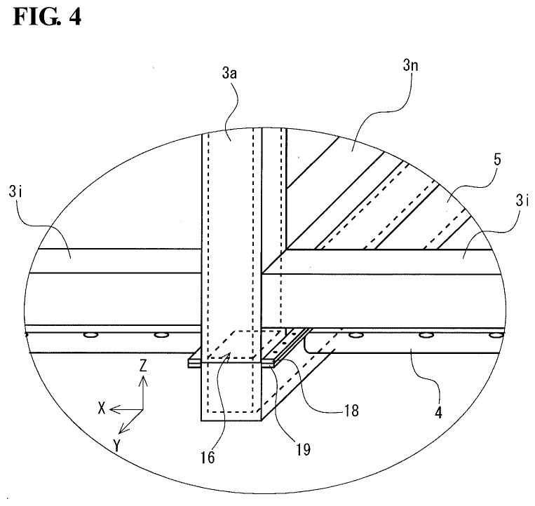

As illustrated in FIG. 4, the gas-introducing tube 5 extends linearly. The gas-introducing tube 5 has both ends in the center axis direction sealed by end walls, thereby having a form that includes a hollow internal space. The gas-introducing tube 5 includes an upper wall and a bottom wall that oppose each other, and, in the present embodiment, the outer shape of the gas-introducing tube 5 perpendicular to the center axis is rectangular. The gas-introducing tube 5 is disposed between the rows of the plurality of filtration modules 1 in plan view. The gas-introducing tube 5 includes a gas inlet 16 in the upper wall on one end side in the center axis direction. Note that “the gas-introducing tube is disposed between the rows of the plurality of filtration modules in plan view” includes a state in which the gas-introducing tube overlaps inner end portions of the plurality of filtration modules in plan view.

The material of the gas-introducing tube 5 is not particularly limited; examples of the material are a metal, such as stainless steel, steel, copper, aluminum, or the like, and a synthetic resin, such as an acrylic resin, polyethylene, polyvinyl chloride, an acrylonitrile-butadiene-styrene copolymer (ABS resin), or the like.

The plurality of aeration tubes 4 are in communication with the gas-introducing tube 5 and extend outwardly in opposing directions (X direction) from a pair of opposing side walls of the gas-introducing tube 5. An end-portion opening of each of the plurality of aeration tubes 4 on a side opposite to the side connected to the gas-introducing tube 5 may be open to the atmosphere (in a liquid to be treated in a used state) or may be sealed. The plurality of aeration tubes 4 each include an aeration portion that has the plurality of aeration holes 12 and a solid-content drainage portion that is continuous from an outer end of the aeration portion and that inhibits a solid content from remaining inside. The aeration portion is disposed such that the center axis thereof extends in the horizontal direction. The solid-content drainage portion may be disposed such that the center axis thereof extends in the horizontal direction or may be disposed such that the center axis inclines downward toward the distal end side. The plurality of aeration tubes 4 preferably extend from opposing locations on the pair of opposing side walls of the gas-introducing tube 5 so as to be positioned, in plan view, between the filtration modules 1 adjacent to each other in each row. Among the plurality of aeration tubes 4 extending from the side walls of the gas-introducing tube 5, the pairs of the aeration tubes 4 disposed on both sides of the gas-introducing tube 5 in the center axis direction are preferably disposed so as to be positioned outside in plan view with respect to the pairs of the filtration modules 1 on the outermost side in each row. Examples of the material of the plurality of aeration tubes 4 include a metal and a synthetic resin similar to those of the gas-introducing tube 5. The sectional shape of each of the aeration tubes 4 perpendicular to the axis direction is not particularly limited; examples thereof are an annular shape and a square-ring shape. The inner diameter of each of the plurality of aeration tubes 4 may be, for example, 6 mm or more and 70 mm or less. Note that the inner diameter of each of the plurality of aeration tubes 4 when the sectional shape of an inner surface of each of the aeration tubes 4 in the axis direction is other than circular denotes an inner diameter obtained through conversion with the sectional shape considered a true circle.

The center of each of the plurality of aeration holes 12 is aligned with a vertical cross section of each of the aeration tubes 4 including the center axis. The plurality of aeration holes 12 are preferably provided in the aeration portion with an equal interval therebetween. The average pitch (center-to-center distance) of the plurality of aeration holes 12 may be, for example, 10 mm or more and 150 mm or less. The shape of each of the plurality of aeration holes 12 is not particularly limited and is preferably circular. The average diameter of each of the plurality of aeration holes 12 may be, for example, 1 mm or more and 10 mm or less. Note that the average diameter when the shape of the aeration holes 12 is other than circular denotes an average diameter obtained through conversion with the shape considered a true circle.

### (Washing Gas)

A gas to be introduced into the washing module 2 is required to have a specific gravity smaller than that of a liquid to be treated. The gas to be introduced into the washing module 2 is preferably an inert gas. Such a gas is not particularly limited; a typical example thereof is air.

### <Frame>

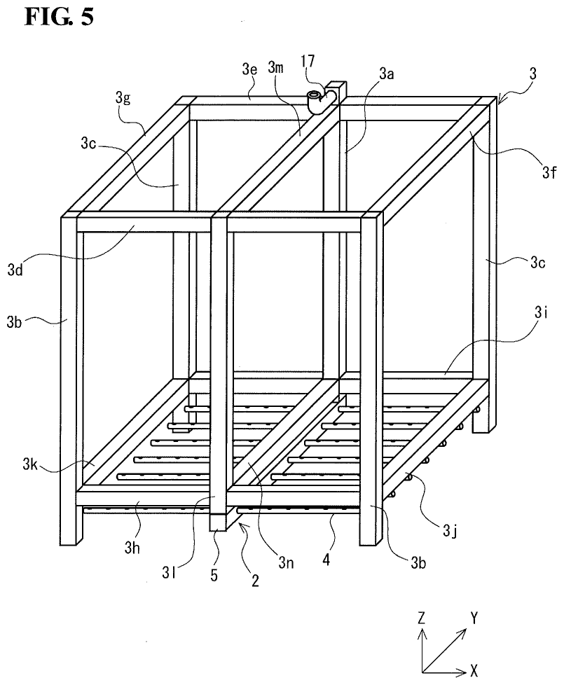

The frame 3 constitutes a support structure of the plurality of filtration modules 1. As illustrated in FIG. 5, the frame 3 includes four vertical frame members that are disposed at four corners of the support structure in plan view, four upper horizontal frame members that are suspended between upper end portions of the vertical frame members adjacent to each other, and four lower horizontal frame members that are suspended between lower end portions of the vertical frame members adjacent to each other. Specifically, the frame 3 includes, as the vertical frame members, a pair of front vertical frame members 3b and a pair of rear vertical frame members 3c that extend in the up-down direction (Z direction) and that are disposed at the four corners of the support structure in plan view. In addition, the frame 3 includes, as the upper horizontal frame members, a front upper frame member 3d, a rear upper frame member 3e, a right upper frame member 3f, and a left upper frame member 3g that are suspended between the upper end portions of the pair of front vertical frame members 3b and the pair of rear vertical frame members 3c and that are disposed in a rectangular shape as a whole in plan view. Moreover, the frame 3 includes, as the lower horizontal frame members, a front lower frame member 3h, a rear lower frame member 3i, a right lower frame member 3j, and a left lower frame member 3k that are suspended between the lower end portions of the pair of front vertical frame members 3b and the pair of rear vertical frame members 3c and that are disposed in a rectangular shape as a whole. The front upper frame member 3d and the rear upper frame member 3e are disposed horizontally and parallel to each other. The front lower frame member 3h and the rear lower frame member 3i are disposed horizontally and parallel to each other. The right upper frame member 3f and the left upper frame member 3g are disposed horizontally and parallel to each other. The right lower frame member 3j and the left lower frame member 3k are disposed horizontally and parallel to each other. In the filtration apparatus, the four vertical frame members and the four upper horizontal frame members and the four lower horizontal frame members that are connected to these vertical frame members form the frame in plan view. The filtration apparatus includes no other members projecting outside the frame in plan view. The frame may include a cover that surrounds the circumference of the entirety of the plurality of filtration modules. The cover is provided by, for example, disposing a plate-shaped member or a film-shaped member in a tense state between the four vertical frame members extending in the up-down direction and two later-described support frame members (a front support frame member 3l and the hollow tube 3a).

The frame 3 includes four support frame members that are disposed in a rectangular shape in side view (as viewed in the X direction) and that are suspended between the four horizontal frame members. Specifically, the frame 3 includes, as the support frame members, the front support frame member 3l that is disposed in the up-down direction and that is connected to the front upper frame member 3d and to the front lower frame member 3h, the aforementioned hollow tube 3a (rear support frame member) that is disposed in the up-down direction and that is connected to the rear upper frame member 3e and to the rear lower frame member 3i, an upper support frame member 3m that is disposed in a front-rear direction and that is connected to the front upper frame member 3d and to the rear upper frame member 3e, and a lower support frame member 3n that is disposed in the front-rear direction and that is connected to the front lower frame member 3h and to the rear lower frame member 3i. In other words, the hollow tube 3a of the filtration apparatus is connected, between the pair of rear vertical frame members 3c, to the rear upper frame member 3e and to the rear lower frame member 3i. Due to the hollow tube 3a being disposed in the up-down direction, it is easy in the filtration apparatus to increase the strength of the frame 3 while supplying a gas to the plurality of aeration tubes 4 through the hollow tube 3a. In addition, due to the hollow tube 3a being connected, between the pair of rear vertical frame members 3c, to the rear upper frame member 3e and to the rear lower frame member 3i, the filtration apparatus is capable of reinforcing the support structure of the plurality of filtration modules 1 by the hollow tube 3a and promoting simplification of the apparatus and efficiency improvement in washing by shortening the gas flow path.

The hollow tube 3a of the filtration apparatus is preferably suspended between the center of the rear upper frame member 3e in the axis direction and the center of the rear lower frame member 3i in the axis direction. Consequently, the filtration apparatus is capable of reinforcing the support structure inside the plurality of filtration modules 1 in each row by the hollow tube 3a. Accordingly, the filtration apparatus is capable of promoting space-saving of the entire apparatus while effectively increasing the strength of the support structure of the plurality of filtration modules 1. The filtration apparatus preferably does not include, other than the hollow tube 3a, a gas supply pipe through which a gas is supplied to the plurality of aeration tubes 4.

Examples of the material of the frame 3 include a metal, such as stainless steel, steel, copper, aluminum, or the like, and, in particular, stainless steel is preferable.

An upper end portion of the hollow tube 3a projects upward from the four upper horizontal frame members. The upper end portion of the hollow tube 3a is in communication with a connecting pipe 17 and is configured such that a gas is fed from a gas pumping device (not illustrated) via the connecting pipe 17. The gas pumping device is not particularly limited; examples thereof are a blower, a compressor, and the like that are publicly known.

A lower end portion of the hollow tube 3a is in communication with the gas-introducing tube 5. Due to the provision of the gas-introducing tube 5 that is in communication with the plurality of aeration tubes 4 and due to the hollow tube 3a being in communication with the gas-introducing tube 5, as described above, the filtration apparatus is capable of supplying a gas to the plurality of aeration tubes 4 through the single hollow tube 3a. Consequently, the filtration apparatus is capable of achieving simplification of the apparatus, which makes it easy to achieve space-saving of the entire apparatus. Moreover, according to such a configuration, the filtration apparatus easily promotes a reduction in the number of components and weight saving of the entire apparatus.

As illustrated in FIG. 4, the hollow tube 3a is in communication with one end portion of the gas-introducing tube 5. Specifically, the hollow tube 3a is formed such that a connected portion connected to the rear upper frame member 3e and a portion below the connected portion have a straight tube shape whose center axis is parallel to the up-down direction (Z direction). The straight tube-shaped portion has a rectangular outer shape perpendicular to the center axis. The hollow tube 3a includes a pair of outwardly projecting flanges 18 on opposing side walls at a lower end portion of the straight tube-shaped portion. As described above, the gas-introducing tube 5 is disposed between the rows of the plurality of filtration modules 1 in plan view and includes the gas inlet 16 in the upper wall on the one end side in the center axis direction. The gas-introducing tube 5 includes a pair of outwardly projecting flanges 19 on a pair of opposing side walls with the gas inlet 16 therebetween. Lower surfaces of the pair of flanges 18 of the hollow tube 3a and upper surfaces of the pair of flanges 19 of the gas-introducing tube 5 are overlaid on each other via packing (not illustrated). These overlaid portions each have a plurality of bolt insertion holes (not illustrated) extending therethrough in a thickness direction. The hollow tube 3a and the gas-introducing tube 5 are connected to each other by bolts being inserted into these bolt insertion holes and by nuts being fastened to the bolts. Due to the single hollow tube 3a being in communication with the one end portion of the gas-introducing tube 5, the filtration apparatus easily supplies air bubbles uniformly from the plurality of aeration holes 12 of the plurality of aeration tubes 4 to the plurality of hollow fiber membranes 11 through the gas-introducing tube 5. In other words, due to the single hollow tube 3a being in communication with the one end portion of the gas-introducing tube 5, a gas flows smoothly from the side of the gas inlet 16 toward the other side inside the gas-introducing tube 5, and the filtration apparatus thus easily supplies a gas uniformly to the plurality of aeration tubes 4 disposed in the axis direction of the gas-introducing tube 5. Consequently, the filtration apparatus is capable of improving washing efficiency of the washing module 2 while achieving space-saving of the entire apparatus.

As described above, the hollow tube 3a, specifically, the connected portion of the hollow tube 3a connected to the rear upper frame member 3e and the portion below the connected portion extend in the up-down direction. The gas-introducing tube 5 is in communication with the lower end portion of the hollow tube 3a. Consequently, the connection structure of the hollow tube 3a and the gas-introducing tube 5 is simplified, and the filtration apparatus thus easily achieves space-saving of the entire apparatus.

The plurality of filtration modules 1 of the filtration apparatus are supported by the frame 3. A structure of the filtration apparatus connecting the frame 3 and the plurality of filtration modules 1 to each other is not particularly limited. The structure that connects the frame 3 and the plurality of filtration modules 1 to each other is, for example, a structure in which a plurality of bar-shaped guide rails (not illustrated) are suspended between the right upper frame member 3f and the upper support frame member 3m and between the left upper frame member 3g and the upper support frame member 3m, in which engaging grooves (not illustrated) to which respective guide rails are engaged are formed in the side walls of the upper holding member 13 and the lower holding member 14 of each of the filtration modules 1, and in which the engaging grooves are engaged with the guide rails.

### OTHER EMBODIMENTS

The embodiment disclosed herein should be considered a non-limiting example in terms of every aspect. The scope of the present invention is not limited to the configurations of the aforementioned embodiment; the scope of the present invention is indicated by the claims and intends to include meanings equivalent to the claims and all modifications within the scope.

For example, a configuration in which the frame includes only the single hollow tube is described in the aforementioned embodiment; however, the filtration apparatus may include a plurality of hollow tubes through which a gas is supplied to the plurality of aeration tubes. The configuration in which a gas is supplied to the plurality of aeration tubes through the plurality of hollow tubes is, for example, a configuration in which hollow tubes are employed as the front support frame member and the rear support frame member described above or a configuration in which hollow tubes are employed as the pair of front vertical frame members and the pair of rear vertical frame members and in which a gas-introducing tube that is in communication with the plurality of aeration tubes is connected to the hollow tubes adjacent to each other to supply a gas to the plurality of aeration tubes through the gas-introducing tube.

The plurality of filtration modules are not necessarily disposed in the two rows and with the equal interval therebetween in each row. The plurality of filtration modules may be disposed, for example, in one row. Moreover, when the plurality of filtration modules are disposed in the two rows and with the equal interval therebetween, the gas-introducing tube is not necessarily disposed between the rows of the plurality of filtration modules in plan view. The gas-introducing tube may be disposed outside the rows. Furthermore, the filtration modules may be configured such that the frame functions as the gas-introducing tube.

As described above, the hollow tube is preferably in communication with one end portion of the gas-introducing tube but may be in communication with, for example, a center portion of the gas-introducing tube in the axis direction. Moreover, when the hollow tube is in communication with an end portion of the gas-introducing tube, the end-portion opening of the gas-introducing tube on one side in the axis direction and the guiding passage of the hollow tube may be in communication with each other.

The washing module of the filtration apparatus may include a plurality of intermittent air bubble generating units that are disposed vertically above the plurality of aeration holes. A specific configuration of the intermittent air bubble generating units is not particularly limited; for example, a configuration in which air bubbles emitted from the aeration holes are retained inside and in which, when the retained amount of the air bubbles exceeds a predetermined amount, large-diameter air bubbles are discharged is employable.

In the filtration apparatus, the drainage nozzles are not necessarily formed on only the upper holding members. In other words, in the filtration apparatus, the drainage nozzles may be formed on both the upper holding members and the lower holding members, and the drainage nozzles may be formed on only the lower holding members. Moreover, the position of each of the drainage nozzles on the upper holding members and the lower holding members is not particularly limited; for example, the drainage nozzles may be formed on end portions of the upper holding members and the lower holding members in the center axis direction. Furthermore, a specific configuration of each of the holding members on the side where the drainage nozzles are not formed is not particularly limited; for example, a configuration in which the plurality of hollow fiber membranes are held in a manner in which openings of the plurality of hollow fiber membranes are closed may be employed, and a configuration in which one hollow fiber membrane is curved and bent into a U-shape and in which a bar member for folding is disposed on the folded portion is also employable.

Specific configurations of the upper holding members, the lower holding members, the hollow fiber membranes, the aeration tubes, the frame, and the like of the filtration apparatus are not limited to the aforementioned configurations; various configurations are employable. For example, each of the aeration tubes does not necessarily include the solid-content drainage portion.

### REFERENCE SIGNS LIST

1 filtration module
2 washing module
3 frame
3a hollow tube
3b front vertical frame member
3c rear vertical frame member
3d front upper frame member
3e rear upper frame member
3f right upper frame member
3g left upper frame member
3h front lower frame member
3i rear lower frame member
3j right lower frame member
3k left lower frame member
31 front support frame member
3m upper support frame member
3n lower support frame member
4 aeration tube
5 gas-introducing tube
11 hollow fiber membrane
12 aeration hole
13 upper holding member
14 lower holding member
15 drainage nozzle
16 gas inlet
17 connecting pipe
18, 19 flange
24 supply pipe
6c rear vertical frame
6d rear horizontal frame
6i outer vertical frames
6j outer horizontal frame

1. A filtration apparatus comprising:
a plurality of filtration modules that each include a plurality of hollow fiber membranes that are arranged adjacent to each other so as to extend in an up-down direction;
a washing module configured to supply air bubbles from below the plurality of filtration modules; and
a frame that supports the plurality of filtration modules,
wherein the washing module includes a plurality of aeration tubes each having a plurality of aeration holes, and
wherein at least a portion of the frame is a hollow tube through which a gas is supplied to the plurality of aeration tubes.

2. The filtration apparatus according to claim 1, wherein the hollow tube is disposed so as to extend in an up-down direction.

3. The filtration apparatus according to claim 2, wherein the washing module includes a gas-introducing tube in communication with the plurality of aeration tubes, and the hollow tube is in communication with the gas-introducing tube.

4. The filtration apparatus according to claim 3, wherein the frame includes the hollow tube as a single hollow tube, and the hollow tube is in communication with one end portion of the gas-introducing tube.

5. The filtration apparatus according to claim 4,
wherein the frame includes four vertical frame members disposed at four corners of a support structure in plan view, four upper horizontal frame members suspended between upper end portions of the vertical frame members adjacent to each other, and four lower horizontal frame members suspended between lower end portions of the vertical frame members adjacent to each other, and
wherein the hollow tube is connected, between a pair of the vertical frame members adjacent to each other, to the upper horizontal frame members and the lower horizontal frame members.
